(19) United States
(12) Patent Application Publication
(10) Pub. No.: US 2004/0179692 A1
(43) Pub. Date: Sep. 16, 2004

(54) Personal data entry and authentication device

(76) Inventor: David Cheng, Conwy (GB)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/387,353

(22) Filed: Mar. 11, 2003

(51) Int. Cl. H04L 9/00

(52) U.S. Cl. 380/278

(57) ABSTRACT

A personal and peripheral data communication device is provided to communicate data in a real-time fashion with a host. The device distinguishes two different modes. The first mode is an active data mode to enter data or retrieve previously entered data. The second mode is a responsive data mode to enter data or retrieve previously entered data. The responsive data mode is triggered on the device by the host or by an application running on the host. Data can be stored on the device and securely protected against unauthorized access by biometric and/or non-biometric means. Data can also be authenticated or secured by cryptography via biometric and/or non-biometric means prior to transmission to the host. The device can be used with a variety of different hosts, and is irrespective of the operating system running on the host or type of application with which the device desires to communicate.

### BACKGROUND

Today's market includes a wide variety of devices that enable a user to interact (interface) with processing or computing devices like, for instance, a computer, an ATM machine, a telephone, an authentication device, a car, a door, or the like. Examples of such devices that allow a user to interact with a computer typically include at least two physically separate devices, i.e. a mouse and a keyboard. Optionally, a user could interact with a computer through devices like a joystick, a graphical input table, a touchpad, a touchscreen or a fingerprint sensor. Interaction devices through which a user could interact and control the functions on devices like, for example, authentication devices, ATM machines, TVs, video/DVD players, audio devices, phones, garage doors, or cars typically include a keypad, buttons or a touchscreen. In general, devices that allow a user to interact or interface with a processing or computing device could either be designed as an integral part of the processing or computing device or be designed as remote/wireless devices.

Processing or computing devices that are in an open public environment are frequently shared with other users. Computers present in, for instance, an Internet Kiosk, Internet Café and hot desk workstation are shared among different users. ATM machines, telephones and authentication devices are shared among the various users, clients or employees using these devices. Since these shared devices are in an open public environment it might be necessary to protect the processing and computing devices with their respective interface devices from potential vandalism. Although protecting the processing or computing device is in most cases feasible, protecting the interface device or the device that requires user interaction could not be easily done. Besides the risk of vandalism, there is still another potential risk factor that is of concern to the public health when interface devices are shared among users. For example, sharing of a keyboard or keypad could be an easy avenue to transmit diseases through e.g. bacteria, viruses or biological agents, or transmit allergens through e.g. cosmetic products. In order to overcome problems with vandalism or health issues, it would be desirable to introduce a personal data entry or communication medium that could be carried by each individual user of a processing or computing device.

The use of a personal data entry or communication medium is also desired in situations where a user wants to exchange personal information or data with a processing or computing device. Personal digital assistants (e.g. PDAs or PocketPCs) provide an elegant solution for a user to organize, store and recall personal information. Personal digital assistants allow a user to transmit or receive data, usually by means of a HotSync or infrared, to and from a computer that is setup by the user to communicate with the personal digital assistant. Even though it would be possible to enter data on a personal digital assistant and transmit this data to another device, current personal digital assistants have several shortcomings. For instance, personal digital assistants are focused on data entry on the personal digital assistant itself, but are not designed for direct data entry on another processing or computing device, or control and/or interact with processes or programs on another processing or computing device in a real time fashion. Another shortcoming of personal digital assistants is that the control surface (e.g. keypad or touchscreen) on a personal digital assistant is limited to mostly data entry or interacting with programs running on the personal digital assistant itself. Yet another example of a shortcoming of a personal digital assistant is that in a multi-device, multi user environment a user might want to utilize a personal digital assistant to exchange and execute personal data on one of these processing or computing devices. The current personal digital assistants do not provide such a feature or flexibility.

Accordingly, there is a need to develop a personal data entry and authentication device that would enable a user to interact and exchange information with data processing or computing devices that could overcome the shortcomings of current devices.

### SUMMARY OF THE INVENTION

The present invention provides a personal and peripheral data communication device to communicate data in a real-time fashion with a host. The host is a data processing or computing device typically running an application with which the device establishes interaction. The device could be a self-supporting device or could be part of an authenticator, a mobile phone, a personal digital assistant, a PocketPC, a pager, a portable storage medium or a remote control. The device distinguishes two different modes in which data could be communicated in real time fashion. The first mode is an active data mode to enter data on the device or retrieve previously entered data from the device. The data could be retrieved from a storage means that is part of the device. The entered data or retrieved data could be communicated in real-time fashion to the host. The communicated data interacts with the host or an application running on the host. The second mode is a responsive data mode to enter data on the device or retrieve previously entered data on the device. The responsive data mode is triggered on the device by the host, i.e. in response to a request from the host or from an application running on the host. The communicated data interacts with the host or an application running on the host. For all communication between the host and the device, a communication means is used and could be based on a wired or a wireless connection.

The type of data that is entered and communicated could be any type of data but is typically related to personal data, encrypted data or personal authentication information. In order to facilitate authentication, an authentication mode is included that allows a user to authenticate him/herself, the entered data, the retrieved data, or a request. The authentication could include non-biometric or biometric authentication means.

A feedback means on board the device such as a display/alert module could be used to alert or provide feedback to a user. Feedback to a user might be desired to alert a user that a request is being submitted, to alert a user that a security validation/authentication is required or to alert a user that data is entered/transmitted. Feedback means alerts the user by either a display, sound, light, vibration or the like. In some situations it might be desired to encrypt and secure data during transmission. Therefore, the device and host could further include key generation logic (e.g. random number asymmetric keys), and/or encryption (de-encryption) logic (e.g. public key encryption) to ensure secure data transmission, which are commonly available in the art.

In order to facilitate all the different modes and control functions, the device includes a control surface. The control surface has one or more control elements such as one or more roller balls, one or more roller bars, one or more joysticks, one or more knobs, one or more switches, one or more buttons, a fingerprint sensor or a voice recognition means. Furthermore, the active data mode or the responsive data mode could include an alphanumeric entry mode, a numeric entry mode, a user function entry mode, a function key entry mode, or a system function key entry mode. Each data mode could include an immediate mode or an accumulation mode.

The device includes means to select one or more items on the device or to select one or more items on the host or application running on the host. The selection means facilitates that a user of the device is capable of selecting desired modes on the device as well as selecting desired locations or GUIs at the host site to enter data. An example of such a selecting means is a pointer means to control a pointing device on the host or the application running on the host.

In view of that which is stated above, it is the objective of the present invention to provide a personal and peripheral data communication device that is capable of interacting at the data level with a host in a real time fashion.

It is another objective of the present invention to provide a device that is capable of sending data to a host as well as receiving and responding to a request for data by the host.

It is yet another objective of the present invention to provide a device that can be used with a variety of different hosts irrespective of the operating system running on the host or irrespective of the type of application with which the device desires to communicate.

It is still another objective of the present invention to provide a device on which the data can be stored and securely protected by cryptography means and biometric and/or non-biometric means.

It is still another objective of the present invention to provide a device from which stored data can be called by a host.

It is still another objective of the present invention to provide a device that allows data to be authenticated by biometric and/or non-biometric means prior to transmission to the host.

It is still another objective of the present invention to provide a device that includes means to alert the user by display, light, sound, and/or vibration when security validation or authentication is required.

It is still another objective of the present invention to provide a device to store personal information.

The advantage of the present invention is that the device provides a personal, pocket size, data communication device that can transmit personal data directly to a host as well as reply to data requests by a host. In addition, the device has build-in security capability to facilitate personal and private data storage and communication.

### BRIEF DESCRIPTION OF THE FIGURES

The objectives and advantages of the present invention will be understood by reading the following summary in conjunction with the drawings, in which:

FIG. 1 shows the interaction between device and host according to the present invention;

FIG. 2 shows an example of an active data mode interaction between device and host according to the present invention;

FIG. 3 shows an example of a responsive data mode interaction between device and host according to the present invention;

FIG. 4 shows an example of the different combinations of modes according to the present invention;

FIGS. 5-6 show an example of system integration at the hardware and software level according to the present invention;

FIGS. 7-10 show examples of the device according to the present invention; and

FIGS. 11-19 show examples of different types of data entry or communication modes according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the present invention is set forth without any loss of generality to, and without imposing limitations upon, the claimed invention.

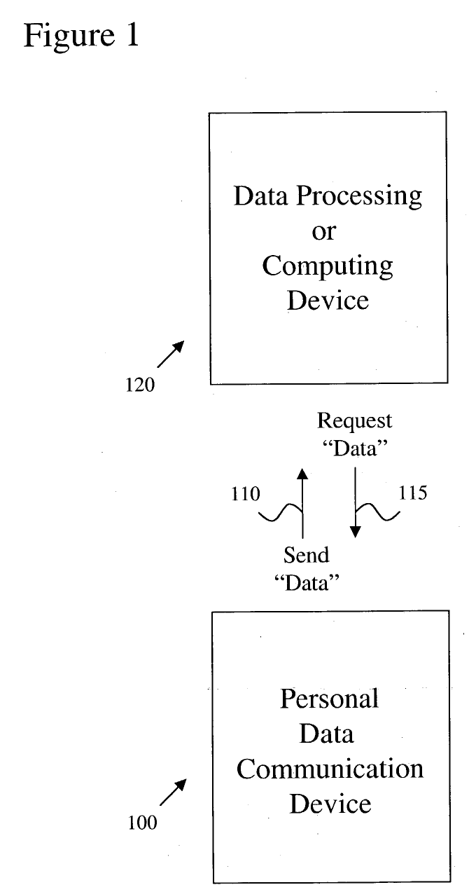

The present invention provides a personal and peripheral data communication device 100 (in brief referred to as device) that is capable of communicating data with a host 120 as shown in FIG. 1. Host 120 is typically a data processing or computing device such as a computer (including desktop computers, laptop computers, PDAs, Pocket PCs, workstations, etc.), bank machines such as ATM machines, authentication devices to acquire access, phone devices, cars, door control units, etc. These are merely some examples of data processing or computing devices 120 that could be used with the teachings of device 100 of the present invention. In general, device 100 could communicate with any data processing or computing device 120 that allows for exchange of information or data that is user-specific, personal, encrypted and/or authentication requests or submissions. With device 100, the owner is enabled with a device for communication, control and exchange of data that is personal, optionally secure and does not have to share with others.

The communication, control and exchange of data are achieved by distinguishing two different data modes. The first data mode is referred to as the active data mode. The second data mode is referred to as the responsive data mode. In the active data mode, a user enters data on device 100 or retrieves data from device 100, which is then sent 110 in a real time fashion to host 120. Device 100 is capable of interacting with host 120 and applications running on host 120 by selecting one or more items to make sure data is entered in the desired location. In the responsive data mode, device 100 receives a request 115 from host 120 to communicate in a real time fashion data to host 120. In the responsive data mode, a user of device-100 will then need to authenticate her/himself to device 100, enter data on device 100 and/or retrieve stored data from device 100 before sending 110 the data to host 120.

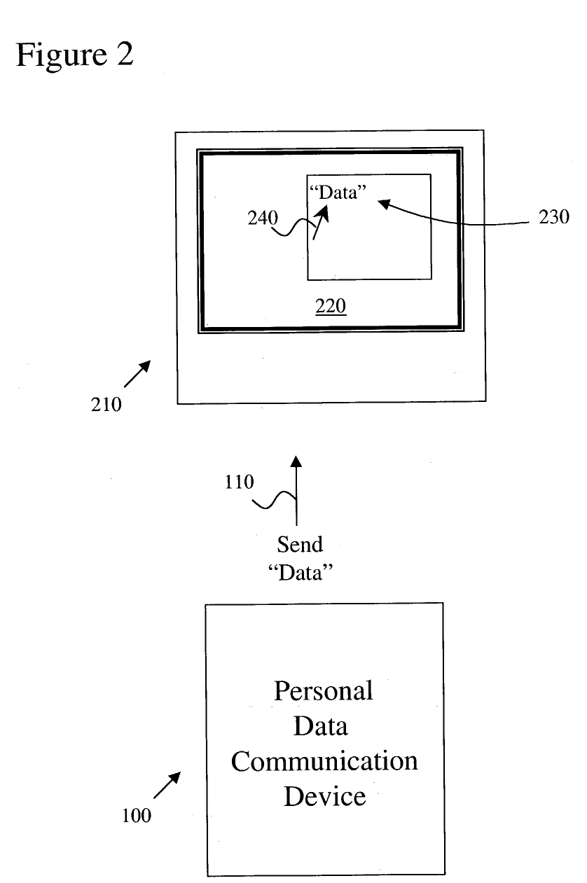

FIG. 2 shows an example of an active data mode. In this example, host 210 includes a display 220. As a person of average skill in the art would readily appreciate, display 220 could be any type of display of a computer, an authentication device, bank machine, etc. Typically in the art, text 230 (“Data”) is entered on host 210 through a keyboard, keypad or touchscreen that comes with or is integrated with device 210. Once text 230 is entered, host 210 includes means to display the entered text on display 220. However, in the present invention, text 230 is not entered using the keyboard, keypad or touchscreen that comes with host 210. Instead, text 230 “Data” is entered on or retrieved from storage device 100 and sent 110 in real-time fashion to host 210. After host 210 has received the text, the transmitted text 230 could be displayed on display 230.

Host 210, as shown in FIG. 2, could also include a selecting means to select one or more items on host 210 or applications running on host 210. An example of a selection means is, for instance, a pointer device 240 that is visualized on display 220. As a person of average skill in the art would readily appreciate, pointer device 240 could take any form or shape and is not limited to the arrow as shown for pointer device 240. Typically in the art, a mouse or touchpad that comes with host 210 controls pointer device 240. However, in the present invention, pointer device 240 is not controlled using the mouse or touchpad that comes with host 210. Instead, pointer device 240 is controlled by device 100. Control signals for pointer device 240 are generated on device 100 and then transmitted 110 to host 210. After host 210 has received the transmitted control signals, host 210 includes means to display the intended movements of pointer device 240 on display 230. Furthermore, host 210 includes means to execute control actions generated on device 100.

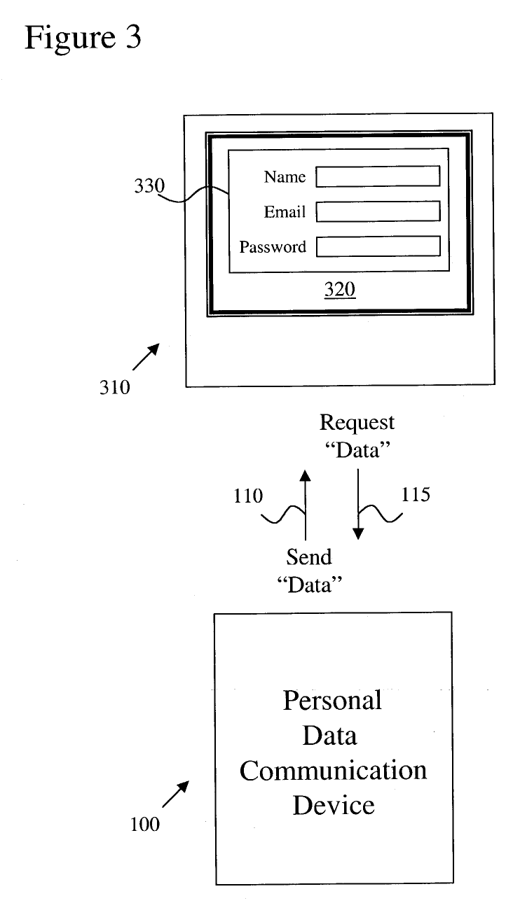

FIG. 3 shows an example of a responsive data mode. Host 310 could for instance run an application such as an Internet Browser running a web-link displayed on display 320. The Internet Browser could request 330 to have the user enter personal information, for instance in subscribing to a service or requesting personal information through a web-link. In the example of FIG. 3, request 330 is to enter “Name”, “Email” and “Password”. Typically in the art, a user types the information on a keyboard after which the entered information is processed in the Browser running a web-link. However, in the present invention request 330 that appears in an application is communicated as a request for data 115 to device 100. As explained supra, a user of device 100 will then need to enter the requested data on device 100 or retrieve from device 100 the requested data, if it was previously entered and stored, before sending 110 the data to host 310. The device could reply to a request in a manual fashion or in an automatic fashion whereby the request is automatically answered (this is for instance possible when a data file is requested).

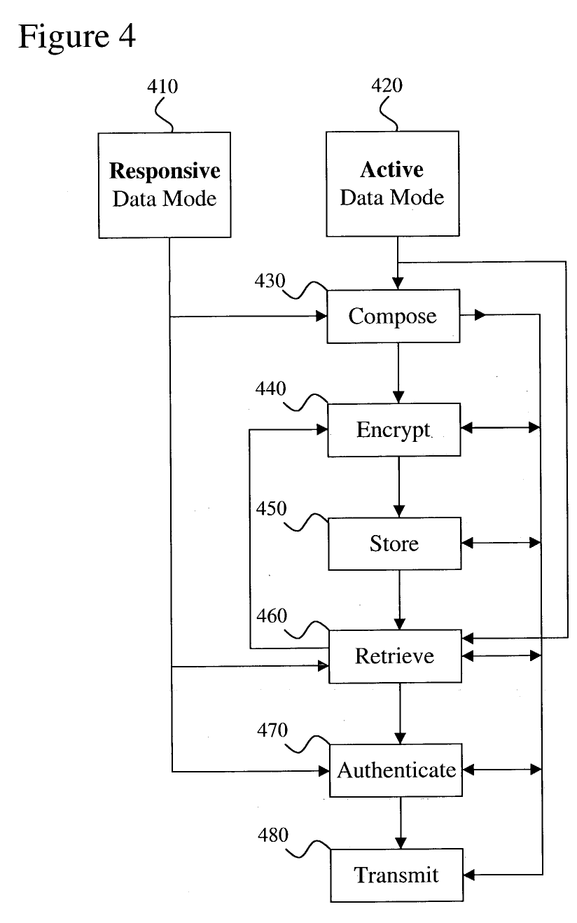

FIG. 4 shows an overview of the different possible scenarios of how data could be handled once in responsive data mode 410 or active data mode 420. For example, a user could select on device 100 different modes to compose 430, encrypt 440, store 450, retrieve 460, authenticate 470 or transmit 480. Different combinations of these modes could be created, such as, without listing all possibilities as a person of average skill in the art would readily appreciate:

1) compose 430 and then transmit 480;

2) compose 430, encrypt 440 and then transmit 480;

3) compose 430 and then store 450;

4) request 410, retrieve 460 and then transmit 480;

5) . . .

6) request 410, authenticate 470 and then transmit 480.

Authentication could be requested by the host, whereby the user is requested to authenticate him/herself, or by the device, whereby the user authenticates him/herself when starting the device or when opening a data file that was protected by an authentication means. The present invention could include biometric (e.g. a fingerprint sensor, microphone to perform speech recognition, a camera to do e.g. facial feature recognition, or the like) or non-biometric (password code, PIN, or the like) authentication means. A user can establish various types of authentication requirement(s) on the device ranging from access of the device to retrieval of a specific record stored on the device. If biometrics means is used the user must enroll his/her required biometrics parameter as part of device setup. The biometrics parameter(s) could be collected from onboard fingerprint sensor, microphone, camera, etc., or supplied from the host. Biometrics matching and cryptography software required for authentication are available in the art.

A feedback means on board the device such as a display/alert module could be used to alert or provide feedback to a user. Feedback to a user might be desired to alert a user that a request is being submitted, to alert a user that a security validation/authentication is required or to alert a user that data is entered/transmitted. Feedback means alerts the user by either a display, sound, light, vibration or the like. In some situations it might be desired to encrypt and secure data during transmission. Therefore, the device and host could further include cryptography software, used in connection with a public key infrastructure (PKI) or not, to ensure secure data transmission, which are commonly available in the art.

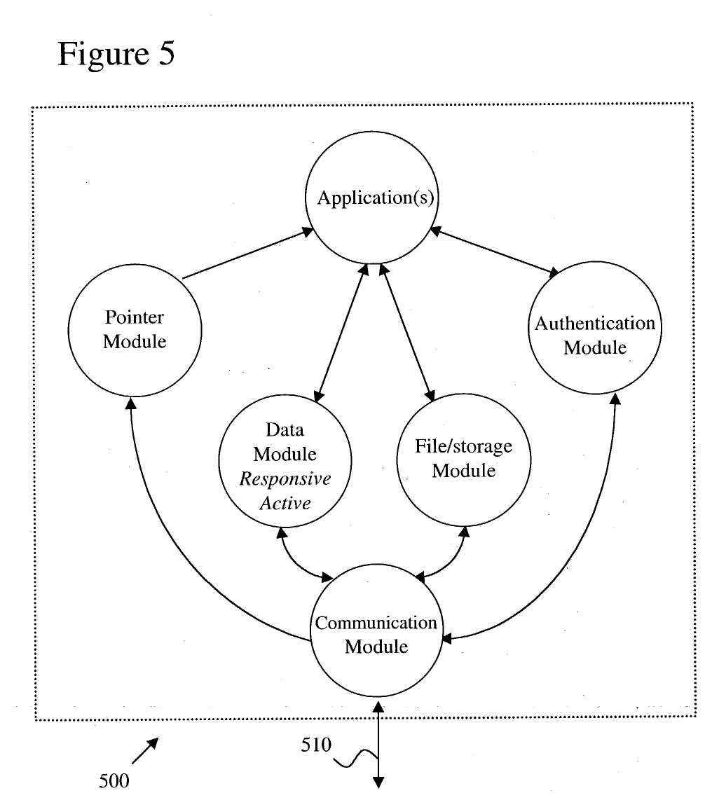

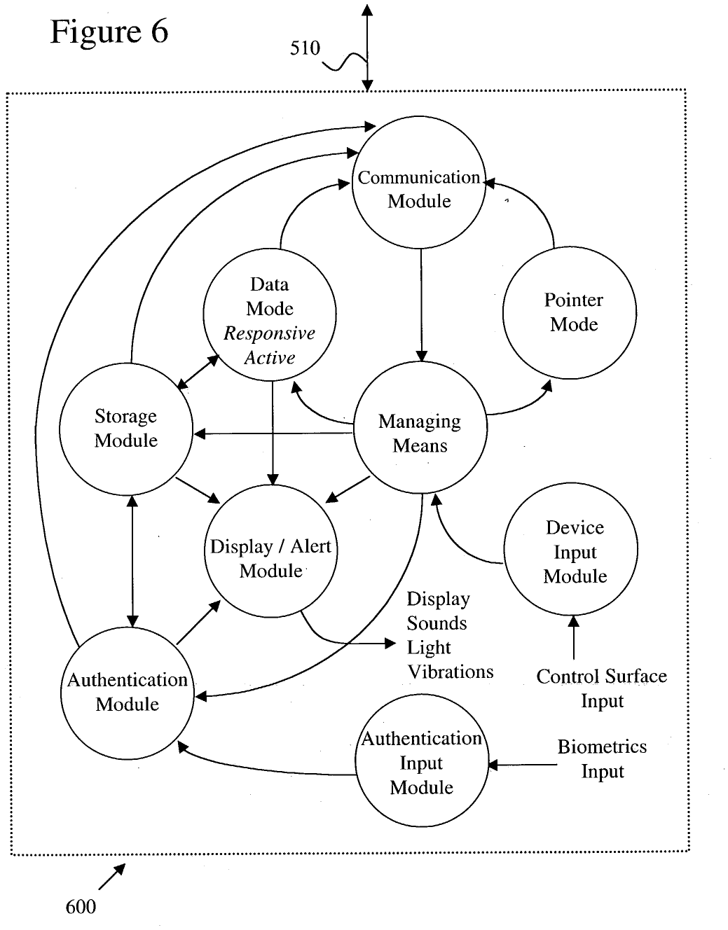

FIGS. 5-6 together show an exemplary embodiment of how the different hardware and software modules or processes could interact. These different modules include the necessary drivers, plug-and-play compatibilities, operating system specific device drivers, authentication specific drivers, APIs and/or biometrics APIs etc., which are available and common in the art. The different modes could be interrupted, which could be accomplished by the user or by an external request from the host. In case a user causes an interrupt, one of the control elements of control surface could be set (for discussion of control surface see infra). This control element would then allow the user to interrupt the mode and return to the main display or previous display. In case a host submits an external interrupt, the external interrupt can be allowed by the device to interrupt the current mode, and the current function data could be saved until external request is responded to before returning to the mode/state prior to the external interrupt. The external request interrupt mode may require the device to retrieve pre-stored data or respond to a cryptograph request. The device could require the user to perform security validation/authentication prior to responding to the request.

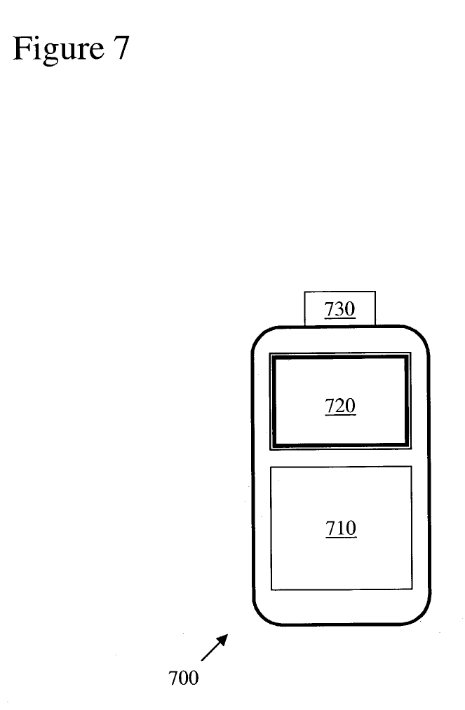

FIG. 7 shows device 700 with a control surface 710, a display 720 and a communication means 730. The key idea of control surface 710 is that it acts as a shared interface for a user to select and switch between the different modes (see FIGS. 4-6). Control surface 710 acts as the control surface for the functionality and selections of each mode; i.e. there is no need for a separate control surface or interface for each mode. In other words, if device 700 has two modes, such as a data entry mode and a pointer mode, control surface 710 is used for the selection and activities available in both modes. In the data entry mode, device 700 assigns a protocol identical to any data entry protocol as it is common in the art. In the pointer mode, device 700 assigns the control surface to a protocol identical to any other pointer device such as mouse or trackball as it is common in the art. Control surface 710 includes one or more control elements that provide the means to select modes, enter data and control functionality on device 700 and/or host. Examples of one or more control elements that could be used include, for example, a roller ball, a roller bar, a joystick, a knob, a switch, one or more buttons, a touchpad, a touchscreen, fingerprint sensor, or the like. Another control element could also include a voice recognition sensor that together with voice recognition software (both available in the art) could initiate the actions. Display 720 provides a visual guide and feedback for navigation, mode selection and data entry. Communication means 730 allows device 700 to act as a peripheral device of a host. Communication means 730 can include a wired (e.g. USB) or wireless (e.g. Bluetooth) communication protocol. The art teaches various kinds of possibilities for such communication and the present invention is not limited to any of these choices. In addition, as a person of average skill in the art would readily appreciate, the communication means needs to be implemented at either end, i.e. the device and the host (See FIGS. 5-6). The electric power required for the device could be supplied through the host via wired communication means 730 (e.g. USB) or by power supply within the device or attached to the device (e.g. battery). Various power supply means could be used which are commonly available in the art.

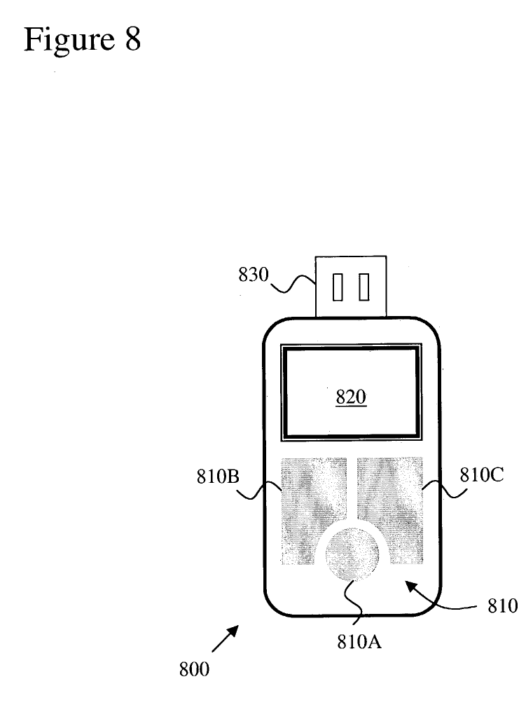

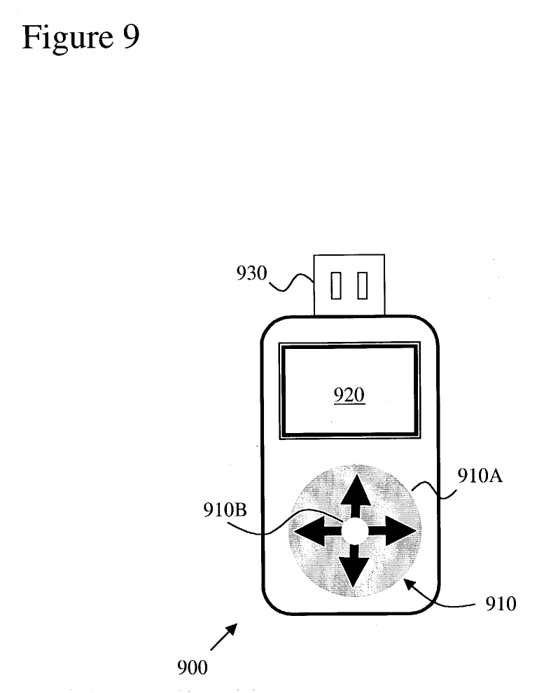

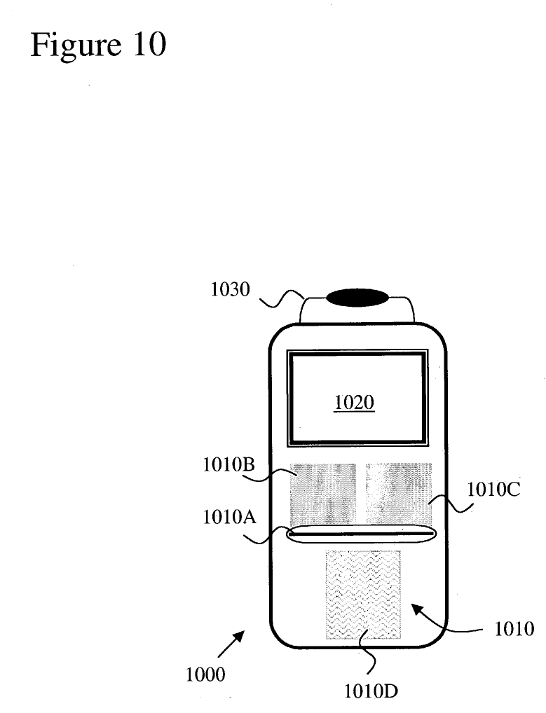

FIGS. 8-10 show different exemplary embodiments of devices 800, 900 and 1000 respectively. Device 800 includes a control surface 810 with a rolling ball and switch 810A, and two buttons 810B and 810C. Device 800 further includes a LCD display 820. As a person of average skill in the art would readily appreciate, display 820 could be any type of display as they are available in the art. An example of the size of display 820 could be a 4×10, i.e. 4 lines/rows and 10 columns to show characters or data. However, as will be discussed infra the display is not limited to a 4×10 and could take any size that is smaller or larger than 4×10. In addition, display 820 could include means to scroll up/down as well as left/right as is common in the art. Furthermore, display 820 could have a line mode to enter data or ASCII codes, or a graphical mode to display icons or graphical images that can be selected and are associated with a particular functionality of a mode. Device 800 includes a USB connector 830 to receive power and enable communications with a processing or computing device.

Device 900 includes a display 920 and communication means 930 that are similar to display 820 and communication means 830 in device 800. However, device 900 has a different type of control surface 910 when compared to control surface 810 in device 800. Control surface 910 includes a disk 910A with a multi-directional button or switch 910B.

Device 1000 differs from devices 800 and 900 in its control surface and communication means, however display 1020 is similar to display 820 and 920. Device 1000 includes a control surface 1010 with a rolling bar 1010A, two buttons 1010B and 1010C and a fingerprint sensor 1010D. The communication means for the device includes an IR remote device 1030. Device 1000 includes an internal power supply, e.g. a battery (not shown).

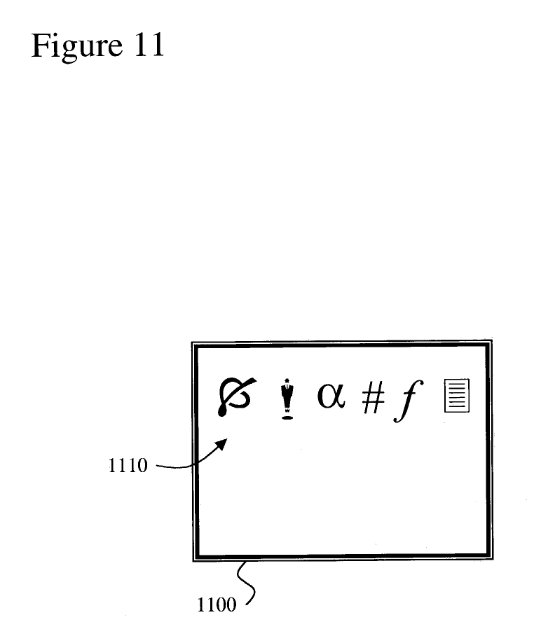

FIGS. 11-19 shows different examples of modes that are managed by a managing means on the device. Managing means manages the functionality, processes and configuration of the different modes and their functions as shown in FIG. 6. As a person of average skill would readily appreciate from FIGS. 11-19, the present invention could include different variations and ways to represent the modes, organize the modes, select the modes, and/or enter data. FIG. 11 shows an exemplary display 1100 of an embodiment with a plurality of modes 1110. In the example of FIG. 11, modes 1110 include a pointer mode [symbol] , a user function entry mode [symbol] , an alphanumeric key entry mode α, a numeric key entry mode #, a function key entry mode f, and a setup/control menu mode [symbol] .

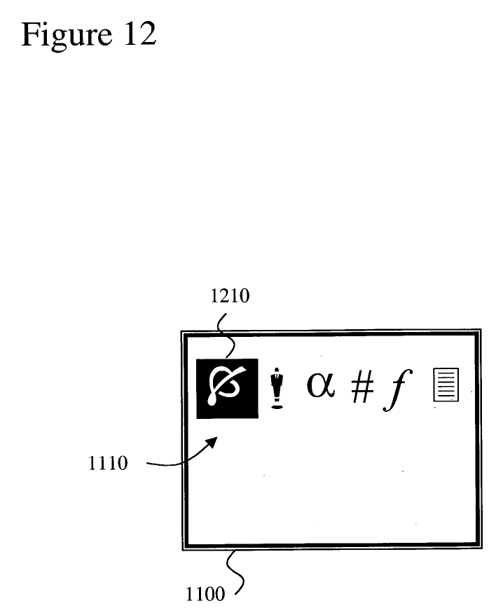

At least one of the control elements of the control surface is assigned to select one of the modes. For instance, a user could use a trackball to toggle through the icons that represent modes 1110 and select a mode. Another way of selecting a mode is to use a cursor, which is displayed in display 1100 and controlled by at least one control element of the control surface. FIG. 12 shows the selection pointer mode [symbol] from modes 1110 (this is shown by highlighting [symbol] ; note that highlighting 1210 is indicated by a black background and a white character in FIGS. 11-19). Once pointer mode [symbol] has been selected and highlighted 1210, clicking for instance the trackball could then activate or launch the pointer mode. As a person of average skill in the art would readily appreciate several different strategies could be designed and programmed to launch modes and switch between different modes. Furthermore, once in a selected mode, the same control element or another control element could be assigned to switch between different modes. Once a mode is selected, one or more of the control elements could be used that are assigned and associated with the functionality for that particular mode. For instance, the pointer mode could use control elements such as a roller/trackball and one or more buttons of the control surface. Once in the pointer mode, the actions of these control elements act on the processing or computing device as discussed with respect to e.g. FIG. 2. Optionally, once the pointer mode is selected and the device is operating in the pointer mode, display 1100 could provide feedback to the user indicating that the device is in pointer mode by displaying “pointer mode” or by showing an activation icon.

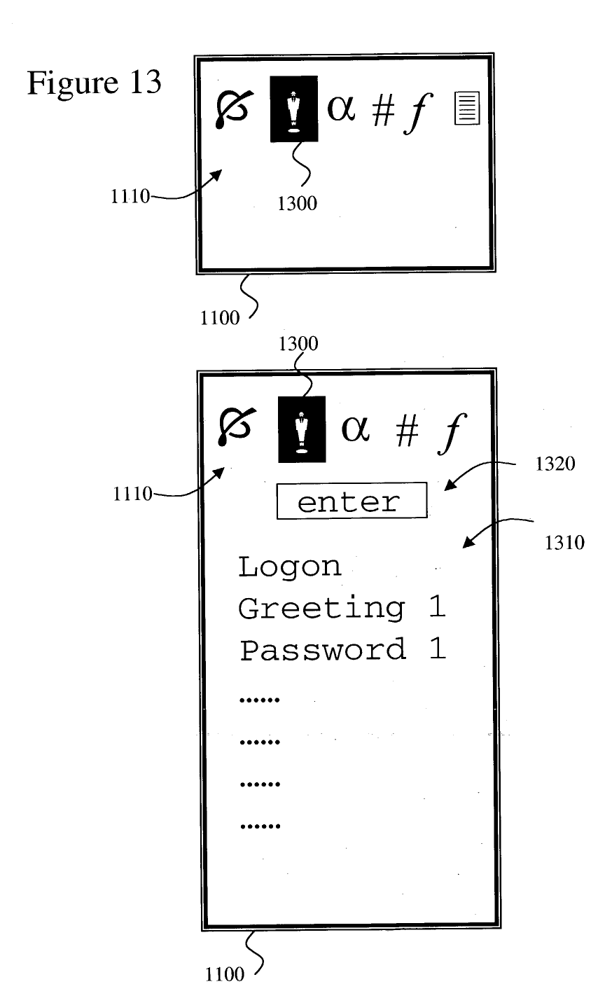

FIG. 13 shows the selection 1300 of a user function entry mode [symbol] that is selected from modes 1110. User function entry mode [symbol] allows a user to select from a menu 1310 of user pre-defined data strings such as Logon, Greeting 1, Password 1, etc. Once a pre-defined data string is selected, using one or more of the control elements, the selected pre-defined data string is transmitted to a processing or computing device. If the selected item is protected by an authentication criteria, then device 1100 will alert user to submit the required authentication before the selected pre-defined data string is transmitted to a processing or computing device. As a person of average skill in the art would readily appreciate, different pre-defined data strings could be defined by a user and are not limited to logon names, greetings or passwords. For instance, a user might transmit pre-defined text files that are associated with a pre-defined data string. Furthermore, the data strings could also be stored in an encrypted format. The function key “Enter” 1320 could be placed in a prominent position for each data entry mode to minimize the need of toggle to the function mode just to use the “Enter”.

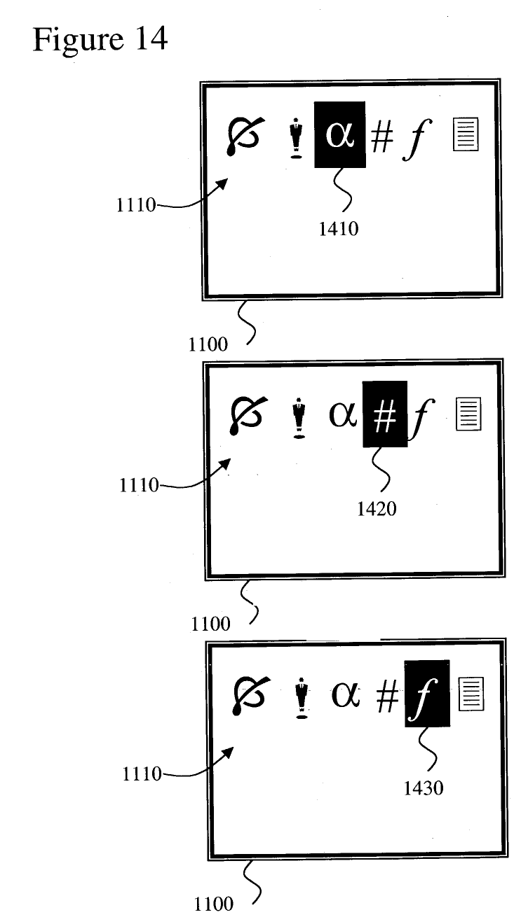

FIG. 14 shows selections of different modes that are associated with the data entry mode. For example, selections 1410, 1420 and 1430 represent a selection of an alphanumeric key entry mode α, a numeric entry key mode #, and a function key entry mode f, respectively. Alphanumeric key entry mode α allows a user to select from a list of characters (alpha, numeric, special characters and/or foreign characters). Numeric entry key mode # allows a user to select from a list of numeric and mathematical characters. Function key entry mode f allows a user to select from a menu of pre-set functions. As a person of average skill in the art would readily appreciate, the format and type of data could also be changed depending on the type of application or program a user is interacting with on the processing or computing device.

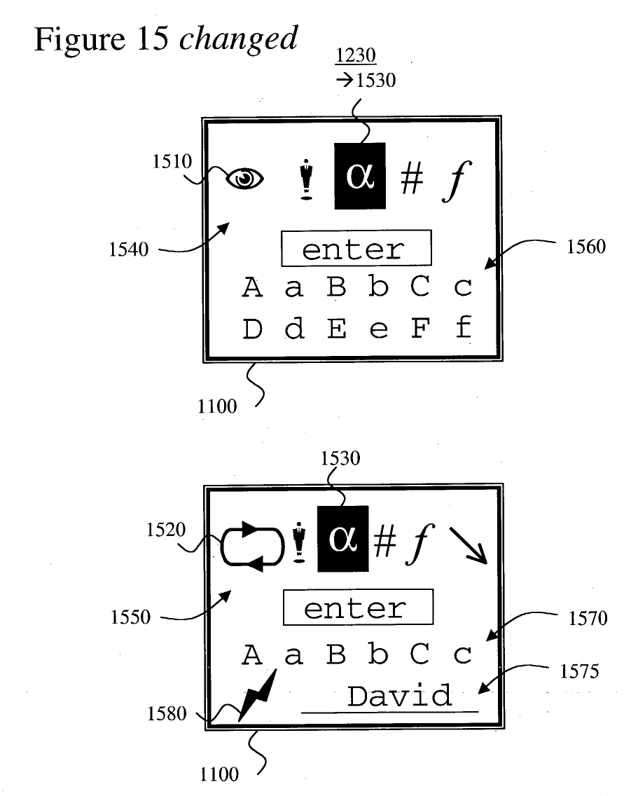

FIG. 15 shows that, once a user has selected one of the data entry modes (i.e. α, # or f), a user can toggle between an immediate data entry mode 1510 or an accumulated data entry mode 1520. For both immediate data entry mode 1510 or an accumulated data entry mode 1520, the alphanumeric mode 1530 was selected as the data entry mode. Once immediate data entry mode 1510 or accumulated data entry mode 1520 is selected, display 1100 shows a new set of modes 1540 and 1550 respectively. Modes 1540 or 1550 include an icon for immediate data entry mode 1510 or an icon for accumulated data entry mode 1520 respectively. In immediate data entry mode 1510, a user could select a letter from displayed letters 1560, which is then immediately transmitted to host. In accumulated data entry mode 1520, a user could select a letter from displayed letters 1570. The selected character is held to create a string such as “David” 1575. Once a user has completed and (optionally) edited text string 1575, the user could activate the icon for transmission 1580 to transmit the created text string to a processing or computing device.

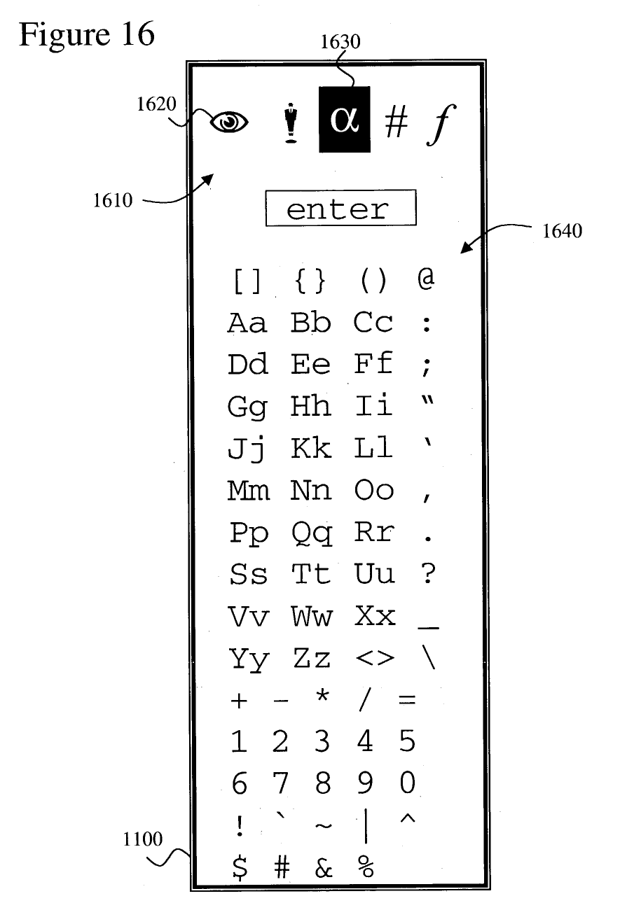

FIG. 16 shows another exemplary embodiment of an extended display 1100. Extended display 1100 shows modes 1610, which among others include a selected immediate data entry mode 1620 and a selected (highlighted) alphanumeric key entry mode 1630. Extended display 1100 further shows characters 1640 that could include a large set of keys, characters or mathematical operators from a standard keyboard as they are used for computers. Since the example of FIG. 16 shows immediate data entry mode 1620, a user could select a letter from displayed letters 1640. Upon selection, the selected data is immediately transmitted to a data processing or computing device. As a person of average skill in the art would readily appreciate, a user could also toggle or select an accumulated data entry mode and proceed similarly as discussed supra with respect to FIG. 15.

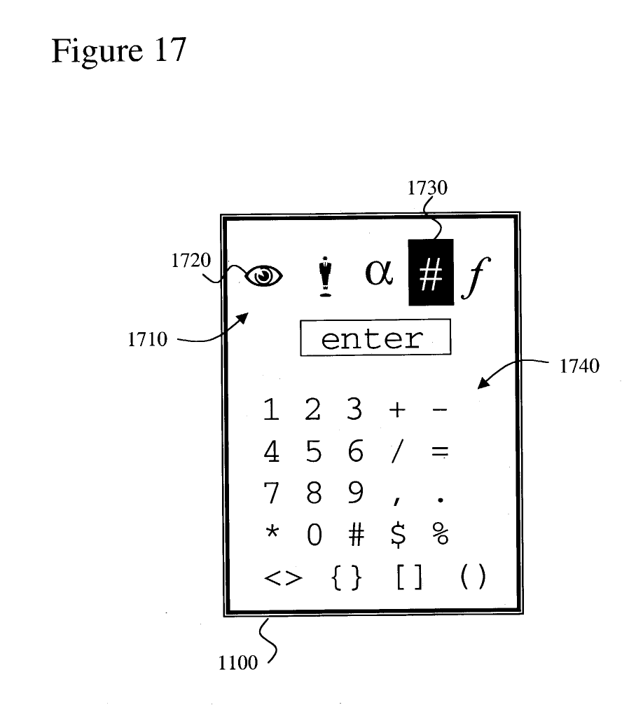

FIG. 17 shows yet another exemplary embodiment of an extended display 1100. Extended display 1100 shows modes 1710, which among others include a selected immediate data entry mode 1720 and a selected (highlighted) numeric key entry mode 1730. Extended display 1100 further shows characters 1740 that could include a large set of numeric keys or characters from a standard keyboard as they are used for computers. Since the example of FIG. 17 shows immediate data entry mode 1720, a user could select a numeric character from displayed numeric characters 1440. Upon selection, the selected numeric character is immediately transmitted to a processing or computing device. As a person of average skill in the art would readily appreciate, a user could also toggle or select an accumulated data entry mode and proceed similarly as discussed supra with respect to FIG. 15.

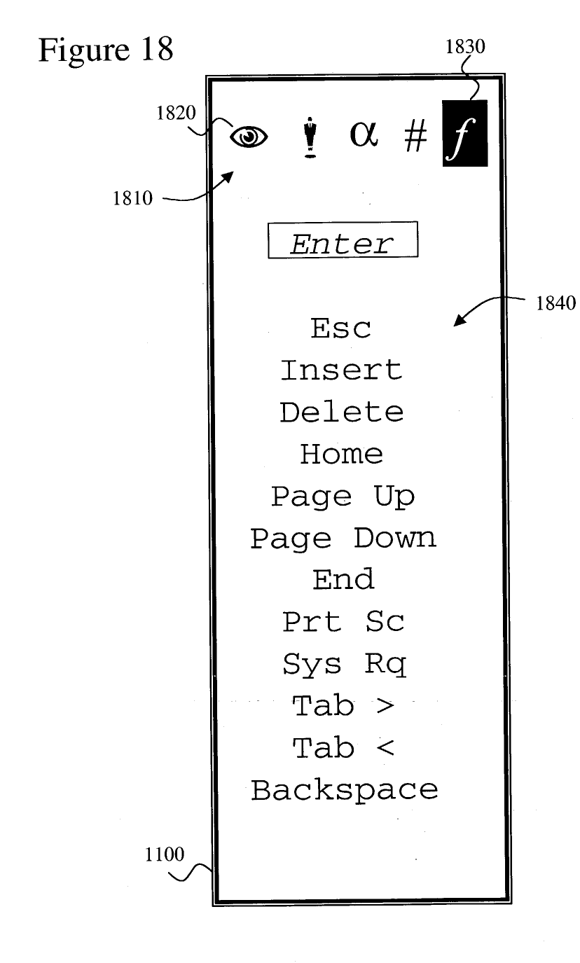

FIG. 18 shows still another exemplary embodiment of an extended display 1100. Extended display 1100 shows modes 1810, which among others include a selected immediate data entry mode 1820 and a selected (highlighted) function entry mode 1830. Extended display 1100 further shows functions 1840 that could include several standard functions such as enter, escape (esc), insert, delete, home, page up, page down, end, print screen (prt sc), system requirements (sys rq), tab >, tab <, backspace, and/or the like as they are commonly used for computer devices and computer applications/programs. Since the example of FIG. 18 shows immediate data entry mode 1820, a user could select a function from displayed functions 1840. The selected function is immediately transmitted to a processing or computing device. At the processing or computing device, the selected and transmitted function is then executed. As a person of average skill in the art would readily appreciate, a user could also toggle or select an accumulated data entry mode and proceed similarly as discussed supra with respect to FIG. 15.

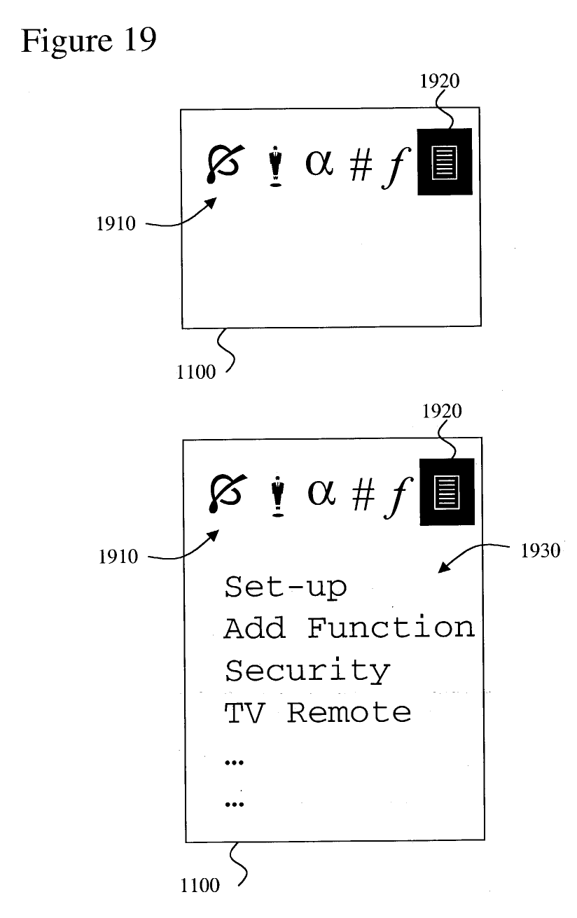

FIG. 19 shows the selection 1920 of a setup/control menu mode that is selected from modes 1910 in display 1100. Setup/control menu mode 1920 allows a user to select from a menu 1930 that includes device setup options, functionality options of the device as well as communication options, encoding of data, authentication methods, designating the device as a TV remote, or the like. Once a setup or control item is selected from menu 1930 using one or more of the control elements, the selected items could be executed. A user could also be asked to accept (deny) the requested change and modify (cancel) the setup or controls (not shown). Managing means could also display a list of settings to further specify or define the setup or controls (not shown).

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. The device could come in different shapes and sizes. However, it would be preferred that the device is sufficiently small to easily fit in a user's pocket and to be portable for day-to-day use. The device could be integrated with tamper resistant/deterrent material or casing in particular to house one or more sensitive and critical components of the device. Examples of tamper deterrent materials that are commercially available are e.g., but not limited to, hard molded plastic shell, casting the components solid in a resin, the use of smartcard, or the like. Critical components are software or hardware parts of the device such as, for instance, but not limited to, processors, chips, electronics, cryptography means (e.g. to perform encryption, decryption, key generation, digital certification, and digital signature), authentication means (e.g. biometrics or non-biometrics parameter validation), device setup means and control means, memory means (e.g. to hold the cryptographic keys, authentication parameters), and/or data storage means (e.g. to store user's biometrics or non-biometrics parameters and/or user stored data for future use).

In order to expand the possibilities that one can have by using the device of the present invention, it might be desirable to include or integrate the device or functionality with a mobile phone, a personal digital assistant, a Pocket PC a pager, a portable storage medium or the like. Portable storage media could be, for instance, an USB-based flash storage device, which is currently the smallest removable storage available. USB-based flash storage devices can hold from 8 MB to 1 GB of data. Power for these USB-based flash storage device is drawn from the USB port.

Depending on the type of application program and country of use, the type of data that could be composed or selected includes western language sets or other language sets, raw ASCII codes, UNICODES, or the like. For instance, a Chinese language set could be used which then would allow the construction of the character(s) using commercially available methods such as phonetic, radical, or the like. All such variations are considered to be within the scope and spirit of the present invention as defined by the following claims and their legal equivalents.

What is claimed is:

1. A personal and peripheral data communication device to communicate data in a real-time fashion with a host, wherein said host comprises a data processing or computing device, comprising:
(a) an active data mode to enter data on said device or retrieve previously entered data from said device, and communicate in said real-time fashion said entered or retrieved data to said host, wherein said communicated data interacts with said host or an application running on said host; and
(b) a responsive data mode to enter data on said device or retrieve previously entered data on said device in response to a request from said host or from said application running on said host received at said device, and communicate in said real-time fashion said entered or retrieved data to said host or said application running on said host, wherein said communicated and requested data interacts with said host or an application running on said host.

2. The device as set forth in claim 1, wherein said entered data or said retrieved data comprises personal data, cryptography information or personal authentication information.

3. The device as set forth in claim 1, further comprising an authentication mode to authenticate said entered data, said retrieved data, or said request.

4. The device as set forth in claim 3, wherein said authentication mode comprises cryptographic means, non-biometric validation means or biometric validation means.

5. The device as set forth in claim 1, further comprising a selection means to select one or more items on said host or said application running on said host.

6. The device as set forth in claim 5, wherein said selection means comprises a pointer means to control a pointing device on said host or said application running on said host

7. The device as set forth in claim 1, wherein said active data mode or said responsive data mode comprises an alpha-numeric entry mode, a numeric entry mode, a user function entry mode, a function key entry mode, or a system function key entry mode.

8. The device as set forth in claim 1, wherein said active data mode or said responsive data mode comprises an immediate mode or an accumulation mode.

9. The device as set forth in claim 1, further comprising a setup mode to setup preferences for a user, an edit mode to edit data, a storage mode to store entered data, a retrieval mode to retrieve stored data or a management mode to manage stored data.

10. The device as set forth in claim 1, further comprising storage means to store data.

11. The device as set forth in claim 1, further comprising security means to protect stored data.

12. The device as set forth in claim 11, wherein said security means comprises cryptographic means, biometric validation means or non-biometric validation means.

13. The device as set forth in claim 1, further comprising a displaying means.

14. The device as set forth in claim 1, further comprising a control surface, wherein said control surface comprises one or more control elements, wherein said one or more element comprises one or more roller balls, one or more roller bars, one or more joysticks, one or more knobs, one or more switches, one or more buttons, a fingerprint sensor or a voice recognition means.

15. The device as set forth in claim 1, further comprising a communication means wherein said communication means comprises a wired or a wireless connection between said device and said host.

16. The device as set forth in claim 1, further comprising alerting means to alert a user of said device.

17. The device as set forth in claim 1, wherein said host comprises means to interpret or execute said communicated data.

18. The device as set forth in claim 1, wherein said device comprises an authenticator, a mobile phone, a personal digital assistant, a PocketPC, a pager, a portable storage medium or a remote control.

19. The device as set forth in claim 1, further comprising one or more tamper deterrent means to house one or more critical components of said device.

20. A method for a personal and peripheral data communication device to communicate data in a real-time fashion with a host, wherein said host comprises a data processing or computing device, comprising the steps of:
(a) providing an active data mode to enter data on said device or retrieve previously entered data from said device, and communicate in said real-time fashion said entered or retrieved data to said host, wherein said communicated data interacts with said host or an application running on said host; and
(b) providing a responsive data mode to enter data on said device or retrieve previously entered data on said device in response to a request from said host or from said application running on said host received at said device, and communicate in said real-time fashion said entered or retrieved data to said host or said application running on said host, wherein said communicated and requested data interacts with said host or an application running on said host.

21. The method as set forth in claim 20, wherein said entered data or said retrieved data comprises personal data, cryptography information or personal authentication information.

22. The method as set forth in claim 20, further comprising the step of providing an authentication mode to authenticate said entered data, said retrieved data, or said request.

23. The method as set forth in claim 22, wherein said authentication mode comprises cryptographic means, non-biometric validation means or biometric validation means.

24. The method as set forth in claim 20, further comprising the step of providing a selection means to select one or more items on said host or said application running on said host.

25. The method as set forth in claim 24, wherein said selection means comprises a pointer means to control a pointing device on said host or said application running on said host.

26. The method as set forth in claim 20, wherein said active data mode or said responsive data mode comprises an alpha-numeric entry mode, a numeric entry mode, a user function entry mode, a function key entry mode, or a system function key entry mode.

27. The method as set forth in claim 20, wherein said active data mode or said responsive data mode comprises an immediate mode or an accumulation mode.

28. The method as set forth in claim 20, further comprising the step of providing a setup mode to setup preferences for a user, an edit mode to edit data, a storage mode to store entered data, a retrieval mode to retrieve stored data or a management mode to manage stored data.

29. The method as set forth in claim 20, further comprising the step of providing storage means to store data.

30. The method as set forth in claim 20, further comprising the step of providing security means to protect stored data.

31. The method as set forth in claim 30, wherein said security means comprises the step of providing cryptographic means, biometric authentication means or non-biometric authentication means.

32. The method as set forth in claim 20, further comprising the step of providing a displaying means.

33. The method as set forth in claim 20, further comprising the step of providing a control surface, wherein said control surface comprises one or more control elements, wherein said one or more element comprises one or more roller balls, one or more roller bars, one or more joysticks, one or more knobs, one or more switches, one or more buttons, a fingerprint sensor or a voice recognition means.

34. The method as set forth in claim 20, further comprising the step of providing a communication means wherein said communication means comprises a wired or a wireless connection between said device and said host.

35. The method as set forth in claim 20, further comprising the step of providing alerting means to alert a user of said device.

36. The method as set forth in claim 20, wherein said host comprises means to interpret or execute said communicated data.

37. The method as set forth in claim 20, wherein said device comprises anauthenticator, a mobile phone, a personal digital assistant, a PocketPC, a pager, a portable storage medium or a remote control.

38. The method as set forth in claim 20, further comprising the step of providing one or more tamper deterrent means to house one or more critical components of said device.
